(19) United States
(12) Patent Application Publication
(10) Pub. No.: US 2014/0094070 A1
(43) Pub. Date: Apr. 3, 2014

(54) ELECTRICAL SOCKET ASSEMBLY AND METHOD OF MANUFACTURING SAME

(71) Applicant: Winchester Electronics Corporation, Wallingford, CT (US)

(72) Inventors: David A. OUELLETTE, Farmington, CT (US); John E. Benham, Torrington, CT (US)

(21) Appl. No.: 13/849,626

(22) Filed: Mar. 25, 2013

Related U.S. Application Data
(60) Provisional application No. 61/614,807, filed on Mar. 23, 2012.

(51) Int. Cl. H01R 13/187; H01R 43/16

(52) U.S. Cl. CPC H01R 13/187; H01R 43/16
USPC 439/843; 29/874

(57) ABSTRACT

An electrical socket assembly includes a socket having an inner peripheral surface defining a cavity for receiving a portion of a contact pin, the inner peripheral surface includes an inner circumferential groove formed therein. The assembly further includes a conformable contact positioned within the circumferential groove such that a portion of the conformable contact protrudes radially inward from the circumferential groove a distance to contact an outer peripheral surface of the contact pin when the contact pin is received within the cavity. A method of forming an electrical socket assembly includes positioning a conformable contact within the circumferential groove such that a portion of the conformable contact protrudes radially inward from the circumferential groove a distance to contact an outer peripheral surface of a contact pin when the contact pin is received within the cavity.

### CROSS-REFERENCE TO RELATED APPLICATIONS

This application claims the benefit of U.S. Provisional Application No. 61/614,807, filed Mar. 23, 2012, which is hereby incorporated by reference in its entirety.

### BACKGROUND OF THE INVENTION

1. Field of the Invention

The present application relates generally to an improved electrical socket assembly and method of manufacturing thereof.

2. Background Art

A large variety of electrical connectors exist for joining electrical circuits. For example, in certain plug and socket connectors, a plug can have one or more pins or prongs that are inserted into openings in the mating socket. In the case of some high voltage socket elements, it can be important to limit the amount of heating from current passing through the connector, in addition to other design considerations.

In some conventional socket connectors, a mating socket can include several inwardly biased electrical contact tines that extend in a longitudinal direction within the mating socket and contact the plug at only one point on each tine. Such a configuration can have undesirable contact resistance and joule heating. The configuration can also result in higher forces on the tine which can decrease durability and service life of the socket connector. Such a configuration can also require a long engagement area between the tine and the plug that can be undesirable in certain socket assemblies. There is therefore a continuous need for improved electrical connector assemblies and related methods.

### SUMMARY OF THE INVENTION

In some embodiments, an electrical socket assembly includes a socket having an inner peripheral surface defining a cavity for receiving a portion of a contact pin. A circumferential groove is formed within the inner peripheral surface of the socket. The assembly further includes a conformable contact positioned within the circumferential groove such that a portion of the conformable contact protrudes radially inward from the circumferential groove a distance to contact an outer peripheral surface of the contact pin when the contact pin is fully received within the cavity.

In some embodiments, a method of forming an electrical socket assembly includes obtaining a socket with an inner peripheral surface defining a cavity for receiving a portion of a contact pin and a circumferential groove formed within the inner peripheral surface of the socket. The method further includes positioning a conformable contact within the circumferential groove such that a portion of the conformable contact protrudes radially inward from the circumferential groove a distance to contact an outer peripheral surface of a contact pin when the contact pin is fully received within the cavity.

These and other embodiments are described herein with reference to the drawings, in which like parts are identified using the same reference numerals.

### BRIEF DESCRIPTION OF THE DRAWINGS

FIG. 1 illustrates a perspective view of a socket assembly and a contact pin in accordance with an embodiment.

FIG. 2 illustrates a cross-sectional view of the socket assembly of FIG. 1 with the contact pin received within the socket assembly.

FIG. 3 illustrates an exploded cross-sectional view of the socket assembly and contact pin of FIG. 1.

FIG. 4 illustrates a cross-sectional view of the socket assembly of FIG. 1.

FIG. 5 illustrates a perspective view of a conformable contact for use with the socket assembly of FIG. 1 in accordance with an embodiment.

FIG. 6 illustrates a sectional view of a portion of the socket assembly of FIG. 1 along line 6-6 of FIG. 4.

FIG. 7 illustrates a sectional view of a conformable contact for use with the socket assembly of FIG. 1 in accordance with an embodiment.

FIG. 8 illustrates a sectional view of a conformable contact assembly seated within a circumferential groove of the socket assembly of FIG. 1 in accordance with an embodiment.

FIG. 9 illustrates a sectional view of another conformable contact assembly seated within a circumferential groove of the socket assembly of FIG. 1 in accordance with an embodiment.

FIG. 10 illustrates a cross-sectional view of the socket assembly and contact pin of FIG. 1 showing various dimensions.

### DETAILED DESCRIPTION

While the present invention may be embodied in many different forms, a number of illustrative embodiments are described herein with the understanding that the present disclosure is to be considered as providing examples and not intended to limit the invention to the preferred embodiments described and/or illustrated herein.

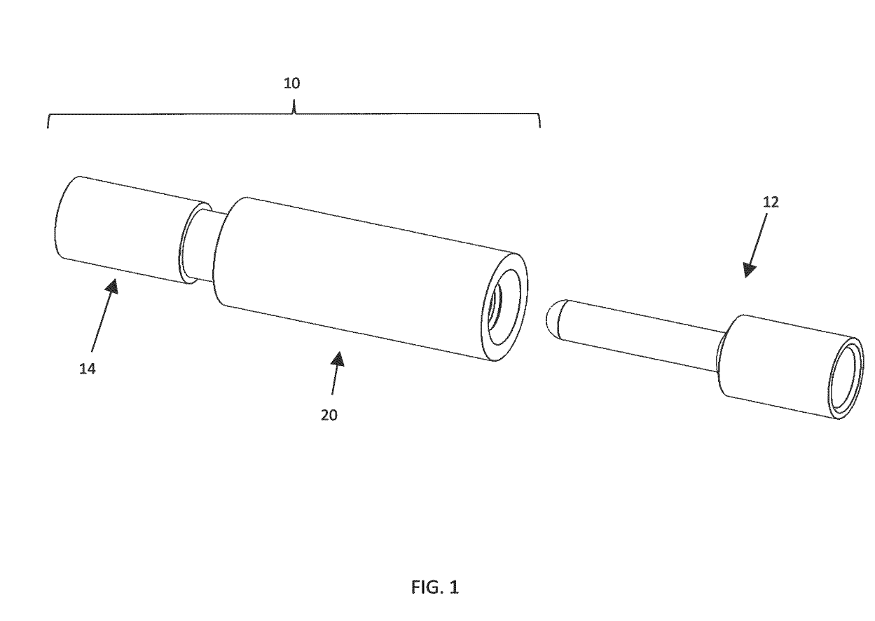

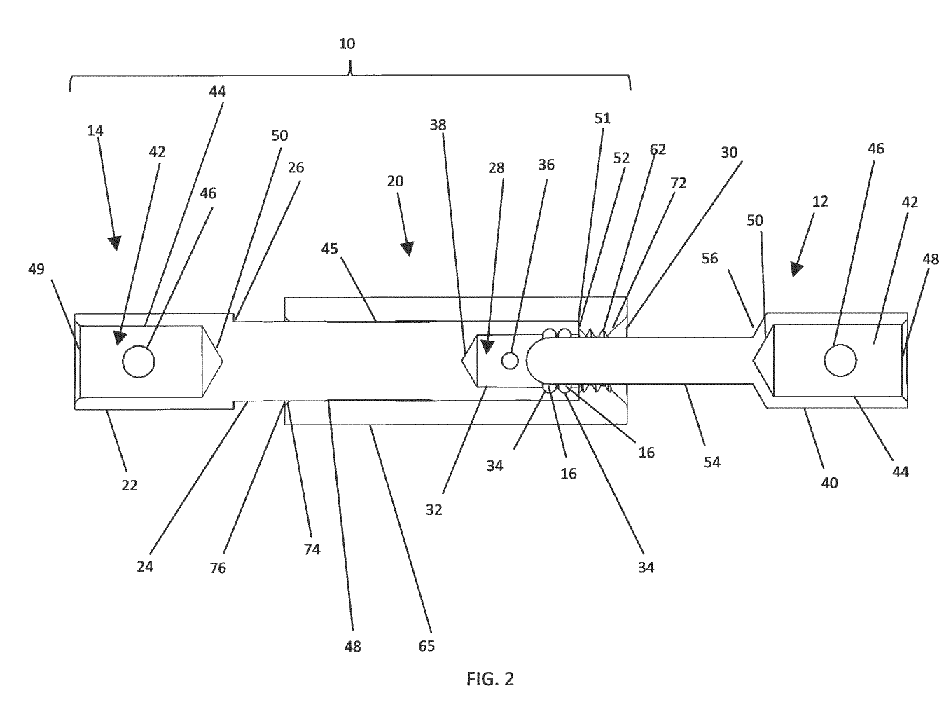

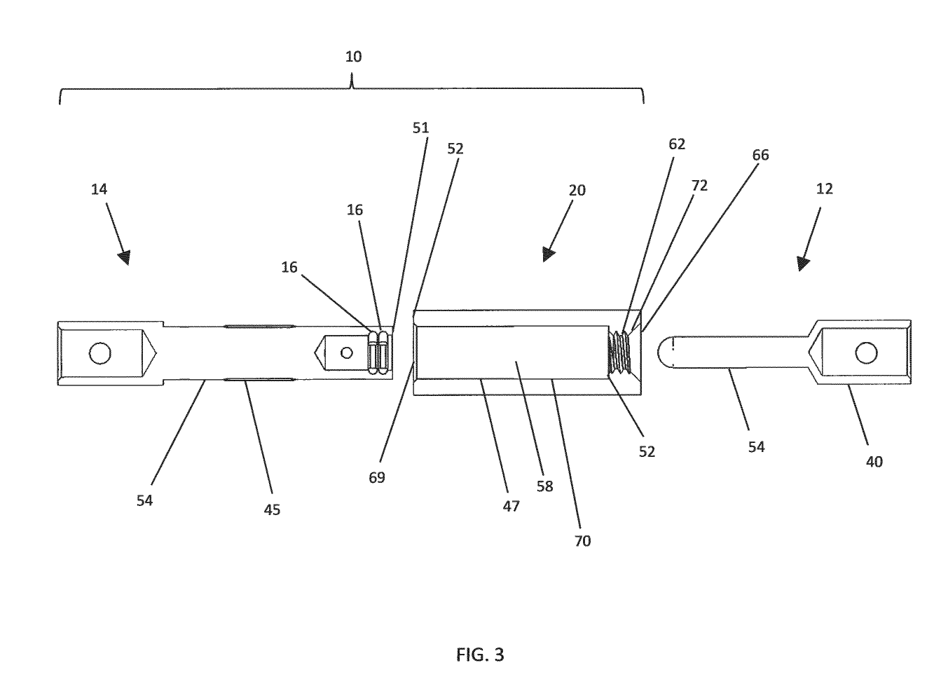

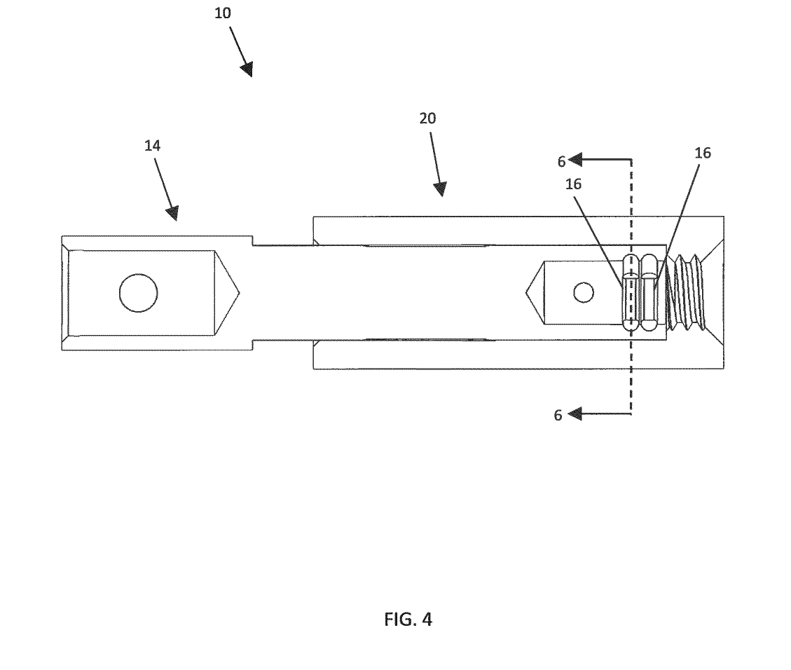

FIGS. 1-4 illustrate various views of a socket assembly 10 according to an embodiment. In particular, FIG. 1 illustrates a perspective view of socket assembly 10 and a contact pin 12, FIG. 2 illustrates a cross-sectional view of socket assembly 10 with contact pin 12 received within socket assembly 10, FIG. 3 illustrates an exploded cross-sectional view of socket assembly 10 and contact pin 12, and FIG. 4 illustrates a cross-sectional view of socket assembly 10.

Socket assembly 10 can, for example, serve as an electrical connector joining two or more electrical circuits to transmit an electrical current therebetween. In some embodiments, socket assembly 10 is used for high voltage applications, such as military and nuclear applications, medical electronics, as well as other applications. In some embodiments, socket assembly 10 can be used to transfer current corresponding to a data signal.

Socket assembly 10 includes socket 14, two conformable contacts 16, and contact shield 20. Socket 14 can be used to electrically connect socket assembly 10 to a first electrical interface (not shown) and to contact pin 12. In some embodiments, socket 14 can be configured for use as a high voltage socket.

Socket 14 is substantially radially symmetrical about its longitudinal axis. The periphery of socket 14 includes an outer peripheral portion 22 and a reduced diameter outer peripheral portion 24 that extends in a longitudinal direction therefrom. A shoulder 26 is defined between outer peripheral portion 22 and reduced diameter outer peripheral portion 24. In some embodiments, the outer peripheral shape of socket 14 can be cylindrical or have another suitable shape.

Socket 14 includes a substantially cylindrical inner peripheral surface 32 defining a cavity 28 at a distal end of socket 14 that is sized to receive contact pin 12. In some embodiments, a small radial gap can be defined between inner peripheral surface 32 and contact pin 12. Cavity 28 has an axial opening 30 at a distal end of socket 14, and a closed axial end 38 at a proximal end of socket 14. In the embodiment shown in FIGS. 2-4, two circumferential grooves 34 are formed in inner peripheral surface 32. In some embodiments, socket 14 can include only a single circumferential groove 34 or more than two circumferential grooves 34. In the embodiment shown in FIGS. 2-4, grooves 34 extend completely around the inner peripheral surface 32 and are axially spaced from one another. In some embodiments, circumferential grooves 34 extend only a portion of the entire circumference of inner peripheral surface 32. Axial end 38 can be substantially conical as shown, spherical, flat, or another suitable shape. A radial opening 36 can be formed in socket 14 and can, for example, be used for coupling socket 14 to another part, or for other uses.

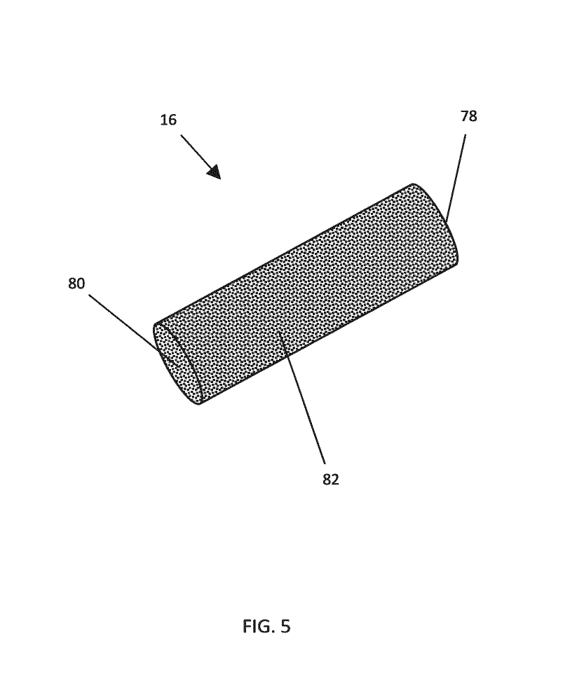

Socket 14 can be configured to electrically connect to contact pin 12 through the use of conformable contacts 16 disposed within cavity 28 of socket 14 as a contact element. For example, conformable contacts 16 are seated within circumferential grooves 34 such that a portion of each conformable contact 16 protrudes radially inward from each circumferential groove 34 a distance to contact an outer peripheral portion 40 of contact pin 12 when contact pin 12 is fully received within cavity 28. The structure, shape, and function of several suitable conformable contacts 16 are described further herein with respect to FIGS. 5-9.

Socket 14 further includes a cavity 42 formed at a proximal end of socket 14 that is sized to receive a wire or other electrical interface (not shown) that allows socket 14 to be electrically connected thereto. Cavity 42 can be defined by a substantially cylindrical inner peripheral surface 44, a circular radial opening 46, an axial opening 48 on a proximal end of socket 14, and an axial end 50. Axial end 50 can be substantially conical, spherical, flat, or another suitable shape. Radial opening 46 can be used for coupling socket 14 to another part, or for other uses.

Socket 14 further includes one or more male splines 45 formed on reduced diameter outer peripheral portion 24 that are configured to mate with female splines 47 (shown for example in FIG. 3) formed on inner peripheral surface 49 of contact shield 20. This relationship allows socket 14 to be rotationally fixed to contact shield 20. Socket 14 further includes an axial face 51 that can contact axial face 52 of contact shield 20 to restrict relative movement therebetween in a first longitudinal direction. Socket 14 can be made entirely or partially of an electrically conductive material or another suitable material. Socket 14 can, for example, be made of ASTM B16 Brass with an H02 temper. Socket 14 can, for example, have the following finish: 0.000030/0.000040 Gold Per ASTM 8488, Type II, Grace C over 0.000080/0.000130 Nickel Per AMS-QQ-N-290 Class 2 (RoHS).

Contact pin 12 is configured to electrically connect socket assembly 10 to a second electrical interface. As described above, contact pin 12 can include an outer peripheral portion 40, contact pin 12 can further include a reduced diameter outer peripheral portion 54 extending in a longitudinal direction therefrom. A shoulder 56 is defined between outer peripheral portion 40 and reduced diameter outer peripheral portion 54. Reduced diameter outer peripheral portion 54 of contact pin 12 is sized to be slidably received within inner peripheral surface 32 of cavity 28 of socket 14 and within a lumen 58 (shown for example in FIG. 3) of contact shield 20.

Contact pin 12 further includes a cavity 60 formed on a proximal end thereof for receiving a wire or other electrical connector (not shown), Cavity 60 is defined by a substantially cylindrical inner peripheral surface 51, an axial end 64, an axial opening 67 on a proximal end of contact pin 12, and a circular radial opening 68. Axial end 64 can be substantially conical, spherical, flat, or another suitable shape. Radial opening 68 can be used for coupling contact pin 12 to another part, or for other uses.

Contact pin 12 can be made entirely or partially of an electrically conductive material or another suitable material. For example, in some embodiments, a proximal portion of reduced diameter outer peripheral portion 54 can be made of a material that is not electrically conductive while a distal portion thereof can be made of electrically conductive material. Contact pin 12 can, for example, have the following finish: 0.000030/0.000040 Gold Per ASTM 8488, Type II, Grace C over 0.000080/0.000130 Nickel Per AMS-QQ-N-290 Class 2 (RoHS).

Contact shield 20 can house socket 14 and contact pin 12. In some embodiments, contact shield 20 can shield the electrical connection between socket 14 and contact pin 12. Contact shield 20 can, for example, be configured for use as a high voltage contact shield. Contact shield 20 can further include one or more sets of threads 62 for securely coupling contact pin 12 to socket assembly 10.

Contact shield 20 has a substantially cylindrical outer peripheral surface 65. As described above, contact shield 20 includes lumen 58. Lumen 58 is defined by a first opening 66 for receiving contact pin 12 and a second opening 69 for receiving socket 14. Lumen 58 is further defined by a substantially cylindrical inner peripheral surface 70 of contact shield 20, as well as axial face 52, threads 62, and opening surface 72. Opening surface 72 can be frustoconical or another suitable shape. Contact shield 20 can include an inner peripheral chamfered edge 74 near second opening 69. Chamfered edge 74 can, for example, be sized to allow for solder 76 to be applied between chamfered edge 74 and outer peripheral portion 22 of socket 14. Contact shield 20 can, for example, be made entirely or partially of an electrically conductive or nonconductive material, or another suitable material. Contact shield 20 can, for example, be made of ASTM B16 Brass with an H02 temper. Contact shield 20 can, for example, have the following finish: 0.000030/0.000040 Gold Per ASTM B488, Type II, Grace C over 0.000080/0.000130 Nickel Per AMS-QQ-N-290 Class 2 (RoHS).

FIG. 5 illustrates a perspective view of one embodiment of conformable contact 16. As described above, conformable contact 16 can be positioned within circumferential groove 34 such that a portion of conformable contact 16 protrudes radially inward from the circumferential groove a distance to contact outer peripheral surface 40 of contact pin 12 when contact pin 12 is fully received within the cavity. Conformable contact 16 can, for example, be substantially cylindrical in shape, with a first end 78, a second end 80, and a circumferential peripheral surface 82 therebetween. Peripheral surface 82 can be sized to create a sufficiently tight connection with contact pin 12 to provide a suitable electrical connection therewith.

Conformable contact 16 can be in the form of a wire mass (e.g., a bundle of one or more conductive filaments resembling steel wool) that is configured to elastically deform and electrically connect contact pin 12 to socket 14 when contact pin 12 is fully received within cavity 28 of socket 14. In some embodiments, conformable contact 16 can be manufactured by forming a long strand of fine wire into an electrically conductive elastic wire mass that offers high levels of conductivity, strength, and oxidation resistance. In some embodiments, a conformable contact 16 is prepared using one or more lengths of a cylindrical wire mass.

The wire mass forming conformable contact 16 can, for example, be compressed into a substantially cylindrical shape. Some examples of suitable conformable contacts 16 can include certain types of FUZZ BUTTONS® brand contact pins, available from Custom Interconnects, LLC, of Centennial, Colo. Other shapes of conformable contact 16 may be used, depending on the application, such as slugs, discs, doughnuts and washers.

In some embodiments, a bunched wire mass structure of conformable contact 16 can allow signals to travel the shortest path through conformable contact 16. The structure and shape of conformable contact 16 can be configured to diminish distortion, resistance and inductance. In some embodiments, the wire can be randomized within conformable contact 16 which in some cases can increase the overall structural integrity and strength of the conformable contact 16.

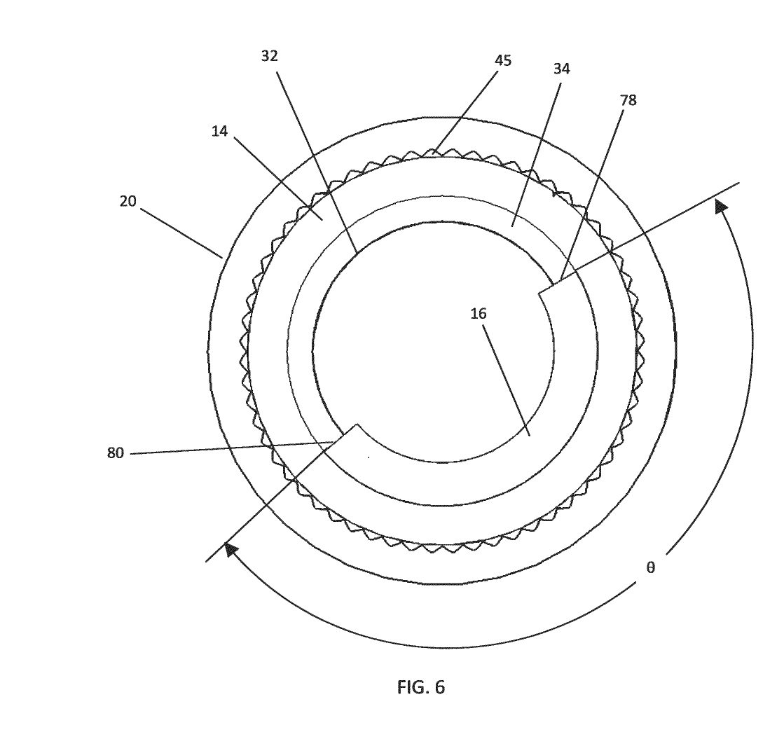

Arranging the conformable contact 16 circumferentially within socket 14 can create a large number of contact points between conformable contact 16 and contact pin 12, thereby resulting in a much larger contact area with contact pin 12 than existing socket configurations. The above configuration of socket assembly 10 can also significantly reduce contact resistance and resulting heating in both the socket assembly 10 and contact pin 12. The large area and lower forces can also provide for improved durability and longer service life. The circumferential orientation of conformable contacts 16 (shown for example in FIGS. 6-9) can provide increased contact area and a shorter length compared to existing contact configurations such as longitudinal tine configurations.

Conformable contacts 16 can be gold plated, for example, and can be made from suitable electrically conductive material, such as Gold-plated Beryllium Copper, Gold-plated Molybdenum, Gold-plated Tungsten, Gold-plated Nickel Chromium, Gold-plated Monel steel, non-plated Monel steel. Suitable diameters for conformable contacts can include, for example, diameters of approximately 0.010″, 0.015″, 0.020″, 0.025″, 0.030″, 0.038″, 0.045″, 0.050″, 0.062″, 0.075″, 0.080″, 0.090″, 0.125″, 0.150″, 0.170″, 0.200″, and 0.280″. Electrical specifications for socket assembly 10 using conformable contacts 16 can, for example be as follows: Contact terminates to cable with about 1 inch diameter silicone rubber, amperage of about 10 amps steady state but with occasionals 3 to 5 KA lasting about ˜100 microseconds, voltage of up to 54,000 volts when in encapsulated cage, a DC modulated frequency, an environmental temperature range from about −50 degrees C. to about 100 degrees C., and mechanical encapsulation.

FIG. 6 illustrates a sectional view of a portion of socket assembly 10 along line 6-6 of FIG. 4. As shown for example in this view, conformable contact 16 can be deformed into a semi-annular shape or another suitable shape when seated within circumferential groove 34 of socket 14. In some embodiments, one or more conformable contacts 16 seated in groove 34 are configured to extend less than the full length of groove 34, thereby covering an angle θ between first end 78 of conformable contact 16 and second end 80 of conformable contact 16. In some embodiments conformable contact 16 can be sized such that angle θ is approximately 170 degrees, thereby creating a gap covering approximately 190 degrees of circumferential groove 34. Such a gap can be configured to allow conformable contact 16 to circumferentially expand when radially compressed by contact pin 12.

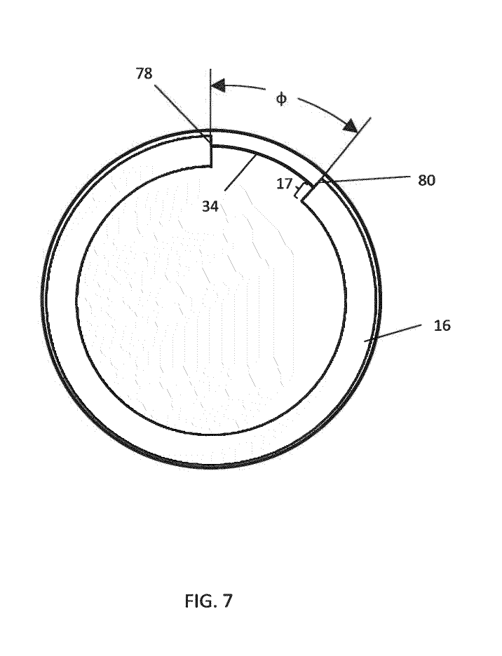

FIG. 7 illustrates a sectional view of another embodiment of a conformable contact 16 seated within circumferential groove 34. In some embodiments, conformable contact 16 can be sized such that it covers an angle between first end 78 and second end 80 of approximately 320 degrees, thereby creating a gap angle φ of approximately 40 degrees.

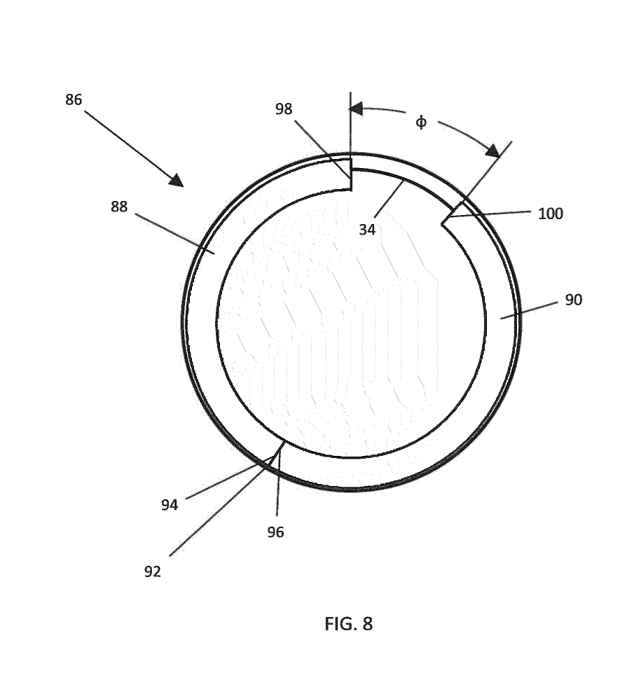

FIG. 8 illustrates a sectional view of a conformable contact assembly 86 seated within circumferential groove 34. Conformable contact assembly 86 can, for example, include two conformable contacts 88 and 90 that abut at a joint 92 formed by respective first ends 94 and 96, and create a gap having a gap angle φ between respective second ends 98 and 100. Conformable contact 16 can protrude radially inward from groove 34 a distance 17 greater than any radial gap between socket 14 and contact pin 12 (e.g., approximately 0.013″ or another suitable distance given the compressibility of conformable contact 16. In some embodiments, groove 34 can be sized to receive multiple conformable contacts 88 and 90 within groove 34 such that the peripheral surface of first conformable contact 88 abuts the peripheral surface of second conformable contact 90.

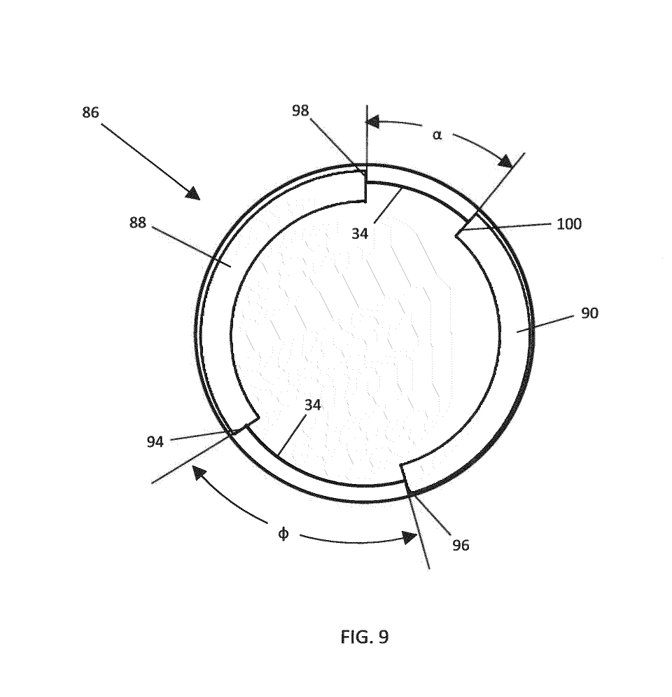

FIG. 9 illustrates a sectional view of another embodiment of a conformable contact assembly 86 seated within circumferential groove 34. Conformable contact assembly 86 can, for example, include conformable contacts 88 and 99 forming a first gap having a gap angle φ formed between respective first ends 94 and 96 of conformable contacts 88 and 90, and a second gap having a gap angle α formed between respective second ends 98 and 100 of conformable contacts 88 and 90. As shown in FIG. 2, socket 14 can, for example, include two longitudinally spaced circumferential grooves. The configurations of the one or more conformable contacts within the first circumferential groove can be the same or different than the configuration of the one or more conformable contacts within the second circumferential groove.

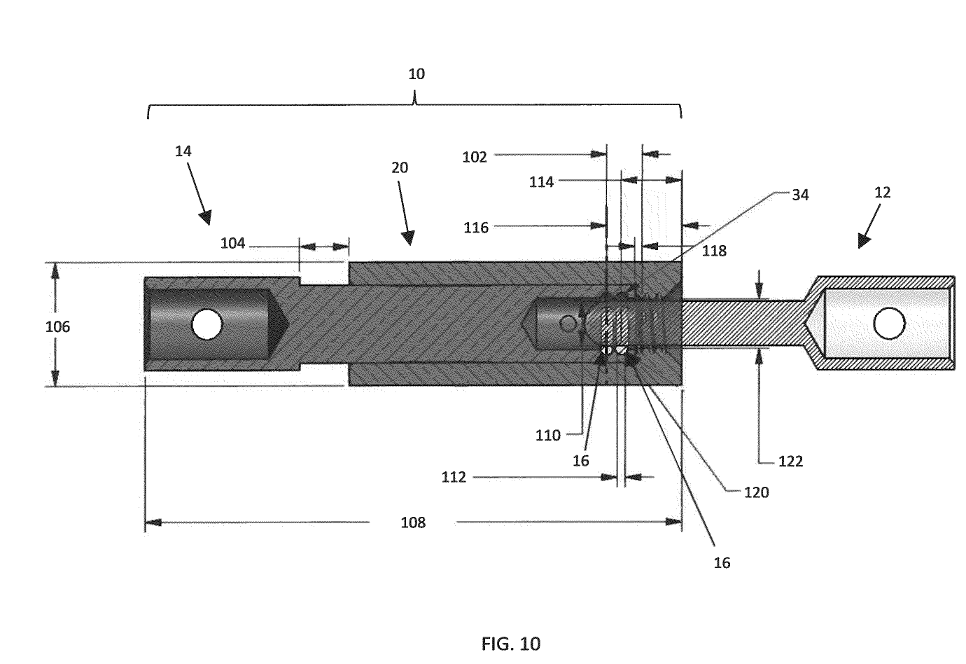

FIG. 10 illustrates a cross-sectional view of one embodiment of socket assembly 10 with contact pin 12 received within socket assembly 10 showing various dimensions. In this embodiment, dimension 102 can be about 0.072″, Dimension 104 can be about 0.100″. Diameter 106 can be about 0.250″. Dimension 108 can be about 1.084″, Diameter 110 can be about 0.090″. Dimension 112 can be about 0.016″. Dimension 114 can be about 0.122″. Dimension 116 can be about 0.152″. Dimension 118 can be about 0.014″. Diameter 120 can be about 0.026″. Dimension 122 can be about 0.100″. Decimal tolerances for dimensions identified herein can, for example, be +/−0.010″.

All numbers in this description indicating amounts, ratios of materials, physical properties of materials, and/or use are to be understood as modified by the word “about,” except as otherwise explicitly indicated. The choice of materials for the parts described herein can be informed by the requirements of mechanical properties, temperature sensitivity, moldability properties, or any other factor apparent to a person having ordinary skill in the art. For example, one more of the parts described herein (or a portion of one of the parts) can be made from suitable metals, alloys, plastics, and/or other suitable materials.

While the embodiments presented herein have been set forth and described in detail for the purposes of making a full and complete disclosure of the subject matter thereof, such disclosure is not intended to be limiting in any way with respect to the true scope of this invention as the same is set forth in the appended claims.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

We claim:

1. An electrical socket assembly comprising:
a socket including an inner peripheral surface defining a cavity for receiving a portion of a contact pin, the inner peripheral surface including an inner peripheral circumferential groove formed therein; and
a conformable contact positioned within the circumferential groove such that a portion of the conformable contact protrudes radially inward from the circumferential groove a distance to contact an outer peripheral surface of the contact pin when the contact pin is received within the cavity.

2. The socket assembly of claim 1, wherein the conformable contact is in the form of an electrically conductive wire mass that is configured to elastically deform and electrically connect the contact pin to the socket when the contact pin is fully received within the cavity.

3. The socket assembly of claim 1, wherein the conformable contact extends less than the full length of the circumferential groove.

4. The socket assembly of claim 1, wherein the conformable contact extends approximately 320 degrees around the circumference of the cavity.

5. The socket assembly of claim 1, wherein the circumferential groove extends fully around the circumference of the inner peripheral surface of the cavity.

6. The socket assembly of claim 1, wherein the conformable contact protrudes radially inward approximately 0.013 inches from the circumferential groove.

7. The socket assembly of claim 1, wherein the conformable contact is deformed into a semi-annular shape when received within the circumferential groove.

8. The socket assembly of claim 1, wherein the circumferential groove of the socket is made of a material that is electrically conductive.

9. The socket assembly of claim 1, wherein the inner peripheral surface of the cavity is substantially the same shape and size as the outer peripheral surface of the contact pin.

10. The socket assembly of claim 1, wherein the inner peripheral surface of the cavity is substantially cylindrical.

11. The socket assembly of claim 1, wherein the conformable contact is in a form of a fine wire that is compressed into a substantially cylindrical shape to produce an electrically conductive, elastic wire mass.

12. The socket assembly of claim 1, further comprising:
a second conformable contact positioned in an end-to-end configuration with the first contact within the circumferential groove.

13. The socket assembly of claim 1, wherein the inner peripheral surface includes a second circumferential groove formed therein, the socket assembly further comprising:
a second conformable contact positioned within the second circumferential groove such that a portion of the second contact protrudes radially inward from the circumferential groove a distance to contact an outer peripheral surface of the contact pin when the contact pin is received within the cavity.

14. The socket assembly of claim 13, wherein the second conformable contact is in the form of an electrically conductive wire mass that is configured to elastically deform and electrically connect the contact pin to the socket when the contact pin is received within the cavity.

15. The socket assembly of claim 1, further comprising a contact pin formed of an electrically conductive material and configured to mate with the socket.

16. A method of forming an electrical socket assembly having a socket including an inner peripheral surface defining a cavity for receiving a portion of a contact pin and a circumferential groove formed within the inner peripheral surface of the socket, the method comprising:
positioning a conformable contact within the circumferential groove such that a portion of the conformable contact protrudes radially inward from the circumferential groove a distance to contact an outer peripheral surface of a contact pin when the contact pin is fully received within the cavity.

17. The method of claim 16, further comprising:
positioning a second conformable contact within the circumferential groove such that an end of the second conformable contact abuts an end of the first conformable contact.

18. The method of claim 16, wherein the socket includes a second circumferential groove formed within the inner peripheral surface of the socket, the method further comprising:
positioning a second conformable contact within the second circumferential groove such that a portion of the second conformable contact protrudes radially inward from the second circumferential groove a distance to contact an outer peripheral surface of the contact pin when the contact pin is fully received within the cavity.

19. The method of claim 18, wherein positioning a second conformable contact within the second circumferential groove includes positioning the second conformable contact such that a gap is formed within the circumferential groove between the first conformable contact and the second conformable contact.

20. The method of claim 18, wherein positioning a second conformable contact within the second circumferential groove includes positioning the second conformable contact such that multiple gaps are formed within the circumferential groove between the first conformable contact and the second conformable contact.

21. The method of claim 16, further comprising:
preparing a conformable contact using a wire mass.

22. The method of claim 21, wherein preparing a conformable contact includes using a length of a cylindrical wire mass.

23. The method of claim 16, further comprising:
positioning a contact pin within the cavity such that the contact pin electrically mates with the conformable contact.
